(19) United States
(12) Patent Application Publication
(10) Pub. No.: US 2023/0281492 A1
(43) Pub. Date: Sep. 7, 2023

(54) ADVERSARIAL DATA GENERATION FOR VIRTUAL SETTINGS

(71) Applicant: International Business Machines Corporation, Armonk, NY (US)

(72) Inventors: Celia Cintas, Nairobi (KE); Waheeda Banu Saib, Johannesburg (ZA); Girmaw Abebe Tadesse, Nairobi (KE); Aisha Walcott, NAIROBI (KE)

(21) Appl. No.: 17/685,350

(22) Filed: Mar. 2, 2022

(51) Int. Cl. G06N 5/04; G06N 3/04; G06N 5/02; G06T 5/00

(52) U.S. Cl. CPC G06N 5/045; G06N 3/0454; G06N 5/022; G06T 5/005; G06T 2207/20084

(57) ABSTRACT

Protected features from media that enable bias in a decision-making process of an artificial intelligence (AI) system are identified and ranked. Adversarial artifacts are generated, using a generative adversarial network, to obfuscate at least a portion of the ranked protected features and the adversarial artifacts are integrated into the media.

### BACKGROUND

The present invention relates to the electrical, electronic and computer arts, and more specifically, to machine learning systems.

The use of artificial intelligence (AI) for advertisement and market search in social networks has become increasingly ubiquitous over the last few years. Algorithmic decision-making is becoming increasingly common as a new source of advice in online marketing. While films implement algorithmic decision-making to save costs as well as increase efficiency and objectivity, algorithmic decision-making may also lead to the unfair treatment of certain groups of people, implicit discrimination, and perceived unfairness. Potential customers are searched from short video conferences in social networks/streaming media/video sharing apps without any awareness that an algorithm will be the first assessor and extractor of potential demographic information for targeted advertisement. The use of machine learning algorithms in each of these steps can lead to fairness issues of AI-driven marketing systems or even susceptibility to spurious correlations.

### SUMMARY

Principles of the invention provide techniques for adversarial data generation in virtual settings. In one aspect, an exemplary method includes the operations of identifying protected features from media that enable bias in a decision-making process of an artificial intelligence (AI) system; ranking the identified protected features; generating, using a generative adversarial network, adversarial artifacts to obfuscate at least a portion of the ranked protected features; and integrating the adversarial artifacts into the media.

In one aspect, an apparatus comprises a memory and at least one processor, coupled to the memory, and operative to perform operations comprising identifying protected features from media that enable bias in a decision-making process of an artificial intelligence (AI) system; ranking the identified protected features; generating, using a generative adversarial network, adversarial artifacts to obfuscate at least a portion of the ranked protected features; and integrating the adversarial artifacts into the media.

In one aspect, a computer program product comprises a computer readable storage medium having program instructions embodied therewith, the program instructions executable by a computer to cause the computer to perform operations comprising identifying protected features from media that enable bias in a decision-making process of an artificial intelligence (AI) system; ranking the identified protected features; generating, using a generative adversarial network, adversarial artifacts to obfuscate at least a portion of the ranked protected features; and integrating the adversarial artifacts into the media.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:

detection of protected attributes in data that unfairly impact decisions by an AI system;

an evaluator to identify the use of protected cues and spurious correlations for decision making;

prospecting of attributes for black-box and grey-box models;

identification of attributes having maximal impact on the decision making of an AI system based on a varying degree of available prior knowledge about the AI-based model;

adversarial generation of data based on potential bias in the AI pipeline and generation of adversarial artifacts to obfuscate protected attributes, cues, and spurious correlations that are integrated into a data stream of media, including video, audio, text, graphics, and the like, to eliminate the potential bias;

a static and adaptative solution of bias mitigation that changes the adversarial data over time;

visual information depicting potential bias and spurious correlation when evaluating a person from the advertisement model perspective;

generators for generating a video or other media incorporating adversarial data that reduces bias in the media, such as real time and offline videos between users, without modifying the aspect of the users; and/or

improvement in the technological process of employing computerized machine learning in various applications by reducing potential for bias.

Some embodiments may not have these potential advantages and these potential advantages are not necessarily required of all embodiments. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 illustrates a flowchart for an example method for the detection and ranking of (potential) protected attributes used in AI-based decision making, in accordance with an example embodiment;

FIG. 4 illustrates an overview for the identification and ranking of (potential) protected attributes for AI-based decision making using black-box and grey-box models, in accordance with an example embodiment;

FIG. 5 is a system overview of an example adversarial data generation system and method, in accordance with an example embodiment; and

FIG. 6 depicts a computer system that may be useful in implementing one or more aspects and/or elements of the invention, also representative of a cloud computing node according to an embodiment of the present invention.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

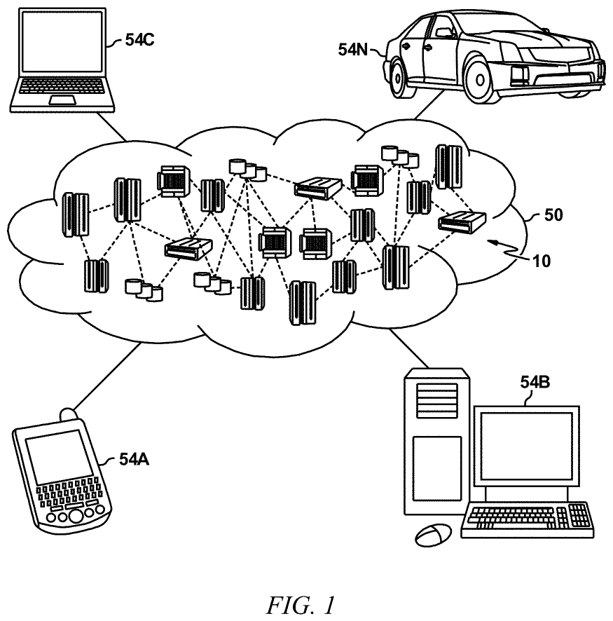

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

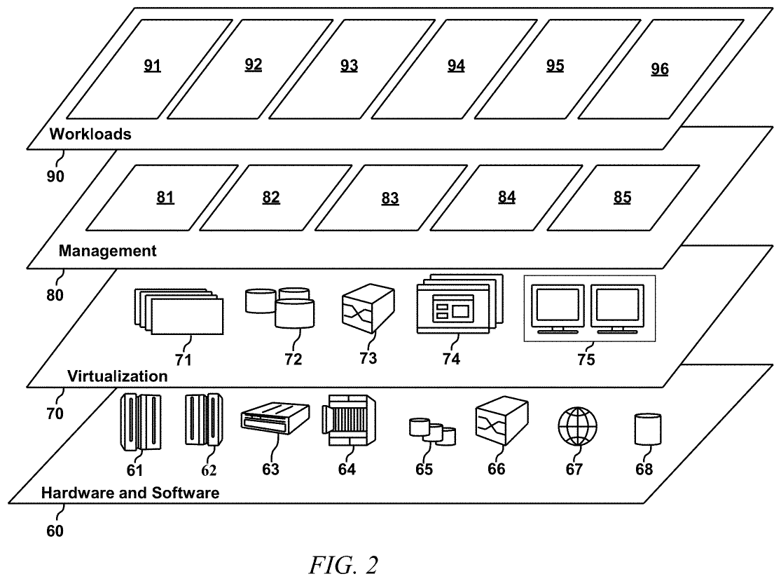

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and at least a portion of an adversarial data generator 96.

Generally, a system and methods are disclosed that audit artificial intelligence (AI) systems used, for example, to analyze customer groups for targeted advertisement in social networks and performance evaluation over video streams in virtual settings and generate real-time artifacts (adversarial data) to control the amount, type, and attributes of information, such as video, audio, voice, text, and the like, to be used in the AI process. In the case of video, the artifacts may be introduced into the whole image, or into only a portion of the image, such as a background image, an image of the individual, and the like. In one example embodiment, the artifacts are imperceptible to a user, such as the focus group analyzer, but are sufficient to remove bias from the media for the AI system.

In one example embodiment, the auditing is performed by detecting the use of protected attributes (such as an individual's age), biasing cues (such as objects in the background) and spurious correlations (such as the appearance of books in an image being indicative of a level of intelligence) in a multi-modal setting (such as visual, audio, textual, graphical, and the like). Protected and biasing cues include, but are not limited to, demographic characteristics and the like. An example of a spurious correlation is a background image of a library, living room, and the like that may portray certain characteristics of a user/potential customer.

In one example embodiment, the system and methods include receiving a plurality of user/potential customer data streams and model characteristics; receiving prior knowledge on the AI system model to be audited (if available) and a plurality of features from the user data stream; identifying the attributes, cues and patterns (spurious correlations) that significantly impact the decision-making of the AI systems (including white-, grey- and black-box model scenarios; selecting and ranking the protected attributes, biasing cues, spurious correlations, and the like; generating adversarial artifacts to obfuscate the protected attributes, protected cues, and spurious correlations by integrating the artifacts into the current stream of information; and integrating the adversarial artifacts into the stream of information.

In one example embodiment, an evaluation is performed to identify the use of protected cues and spurious correlations for decision-making. In the case of a black-box model, prospecting may be performed to identify potential attributes, cues, and spurious correlations by submitting test cases to the AI model and analyzing the predictions of the AI model for bias. For example, an age of an individual may be modified and the impact on the decision-making of the AI system may be detected and quantified.

In one example embodiment, a system and method are disclosed that detect and generate real-time artifacts that modify visual, audio, speech, textual, and/or graphical information to eliminate bias by AI systems used, for example, during a virtual meeting or live streaming. One example method comprises identifying AI systems being used in a social network setting; detecting protected attributes, protected cues, and spurious correlations; ranking the detected protected attributes, protected cues, and spurious correlations; generating adversarial artifacts; and integrating the adversarial artifacts into the current stream of information.

In one example embodiment, prior knowledge (if available) on the AI system model to be audited, and a plurality of features from the user's data stream, are obtained. The existing knowledge about the AI system may vary from full access (such as a white-box model or in-house developed model) to none (such as black box model, including third-party models). The models may be categorized as:

white: full access of the model specifications and data used for training;

grey: medium access of model information (such as knowledge of the features used for training); and

black: no information on the features is available (such as third-party models).

Example types of information include, but are not limited to, sources of data; features used for training per modality; types of pre-processing applied; training and validation performance; and importance of features for decision boundaries.

In the case of a black-box model, potential attributes used for decision making are identified via prospecting or by partially modifying a user's stream of information (such as partially modifying the hair style or other feature characterized by potential protected bias) prior to processing by the AI model. The deviation in the outcome prediction of the AI system is then observed across the subsequent modification of the information streams to detect bias in the predictions. To this end, important features (attributes) are identified using modification-triggered prediction drift, as described more fully below, and compared to the original prediction (without modification). Thus, attributes resulting in the highest divergence in the modification-triggered prediction drift are identified as protected attributes via an efficient search algorithm. If a sufficient number of test users and their corresponding streams/marketing decisions are available, vanilla auto-stratification can be employed to identify the subset of users with a highest likelihood of experiencing the positive and negative outcomes compared to a user's average prediction. When access to the AI model becomes intermediate (grey-box) and full (white-box), the method can be modified by bypassing the steps aimed at prospecting for potential features used for decision making, since these are readily available.

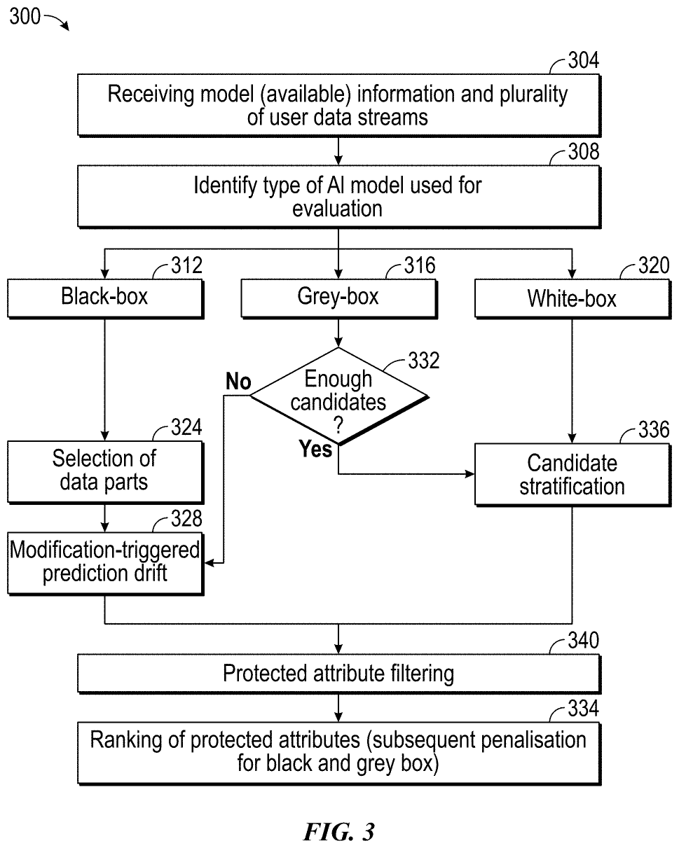

FIG. 3 illustrates a flowchart for an example method 300 for the detection and ranking of (potential) protected attributes used in AI-based decision making, in accordance with an example embodiment. In one example embodiment, information, if available, regarding the AI system and its model, and a plurality of user data streams are obtained (operation 304). The information may include the type of AI model, such as black-box, grey-box, and white-box, a list of attributes considered by the AI model (in the case of a grey-box or white-box model), and the like. Other obtained information includes the type of data used to train the model, the mitigation methods used during pre-processing, during training and postprocessing, current limitations to datashifts, and the like.

The type of AI model, such as black-box, grey-box, and white-box, is identified (operation 308). In one example embodiment, the type of AI model is identified by the information obtained during operation 304. In one example embodiment, the type of AI model is obtained from a user. In one example embodiment, the type of AI model is automatically determined by analysis. For example, the available information may be scanned in search of attributes used by the AI model. If detection of attributes is not found, the AI model may be labelled as a black-box model and if identification of attributes is found, the AI model may be labelled as a white-box model.

If the type of AI model is a black-box model 312, a selection of data parts is performed (operation 324) and a modification-triggered prediction drift evaluation is performed (operation 328), as described more fully below in conjunction with FIG. 7; the method then proceeds with operation 340. In general, during operation 324, the input data for the black-box model is modified and, during operation 328, the predictions generated by the black-box model are evaluated to determine if the prediction changes (drifts) in response to a change of protected attributes (or cues or spurious correlations) that are indicative of bias in the AI model. For example, an age bias may be determined by modifying the age attribute in the input data for the AI model and evaluating whether the black-box model changes its prediction based on the age attribute. The result of the modification-triggered prediction drift evaluation is a list of attributes categorized as protected attributes (those attributes detected as having a negative impact on the fairness of the AI model) or fair attributes (those attributes detected as not having a negative impact on the fairness of the AI model).

If the type of AI model is a grey-box model 316, a check is performed to determine if a sufficient number of (attribute) candidates are available (decision block 332). In one example embodiment, the threshold for the number of candidates to be sufficient is predefined and provided by a user based on the type of AI system. This threshold is estimated as a weighted sum, adjusted to the heterogeneity of the previous customer dataset. Higher variation of demographics requires a higher number of candidates. If a sufficient number of candidates are not available (NO branch of decision block 332), the method proceeds with the modification-triggered prediction drift evaluation of operation 328. If a sufficient number of candidates are available (YES branch of decision block 332), a candidate stratification is performed (operation 336) where the attributes are categorized for filtering and ranking (operation 336). For example, the attributes may be categorized as protected attributes (those attributes detected as having a negative impact on the fairness of the AI model) or fair attributes (those attributes detected as not having a negative impact on the fairness of the AI model). In one example embodiment, this is accomplished by submitting test cases to the AI system and evaluating the results, similar to the modification-triggered prediction drift evaluation.

If the type of AI model is a white-box model 320, candidate stratification, as described above, is performed (operation 336) and the method proceeds with operation 340.

During operation 340, the protected attributes are filtered. For example, fair attributes, as identified during the current iteration of the method 300, may be filtered (excluded) from consideration. In one example embodiment, fair attributes and attributes exhibiting a significant amount of bias, as defined by a user (e.g., the user may be given the opportunity for exceptions/overrides, where appropriate), may be filtered (excluded) from consideration during the current iteration of the method 300.

The protected attributes are ranked (operation 344). For example, the protected attributes may be ranked by the severity of the attribute's negative impact on the fairness of the AI model. Relative importance scores, directly obtained via the white-box model or obtained via a sequence of penalization in the grey and black box models, are utilized to rank the protected attributes in descending order. Conventional techniques are generally available to rank attributes (such as visually discriminative properties of objects) based on their class relevance, i.e., how the classification decision changes when the input is visually slightly perturbed; as well as image relevance, i.e., how well the attributes can be localized on both clean and perturbed images.

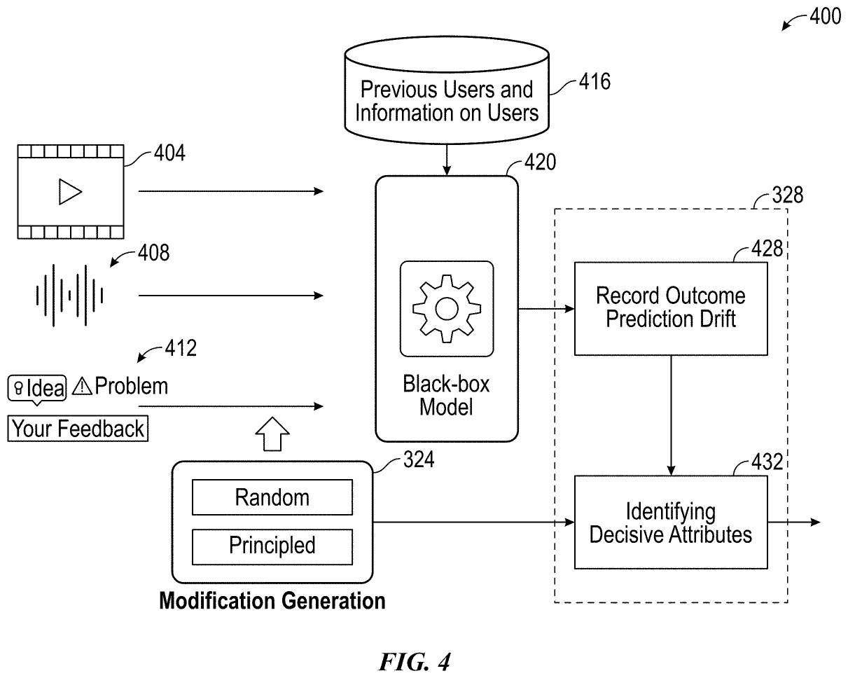

FIG. 4 illustrates an overview 400 for the identification and ranking of (potential) protected attributes for AI-based decision making using black-box and grey-box models, in accordance with an example embodiment. In one example embodiment, video data 404, audio data 408, and textual/graphical data 412 are processed by, for example, a black-box model 420. The black-box model 420 is trained using previous users and information on existing user from a database 416. As described above, the input data for the black-box model is modified during operation 324 and the predictions generated by the black-box model are evaluated to determine if the prediction changes (drifts) in response to a change of attributes that are indicative of bias in the AI model. The modification may be randomly generated, may be principled, or both, and may encompass the whole input space or a portion of the input space. A principled modification is, for example, a modification of an attribute known or suspected of being a protected attribute. The predictions resulting from the modification to the input data are evaluated and the drift in the prediction is determined and recorded (operation 428). In one example embodiment, a subset scan method is used to detect if the probabilistic classifier (the AI model) has statistically significant bias—over or under predicting the risk—for some subgroup, and to identify the characteristics of this subgroup. The decisive attributes, that is, the attributes that caused the prediction drift are identified (operation 432).

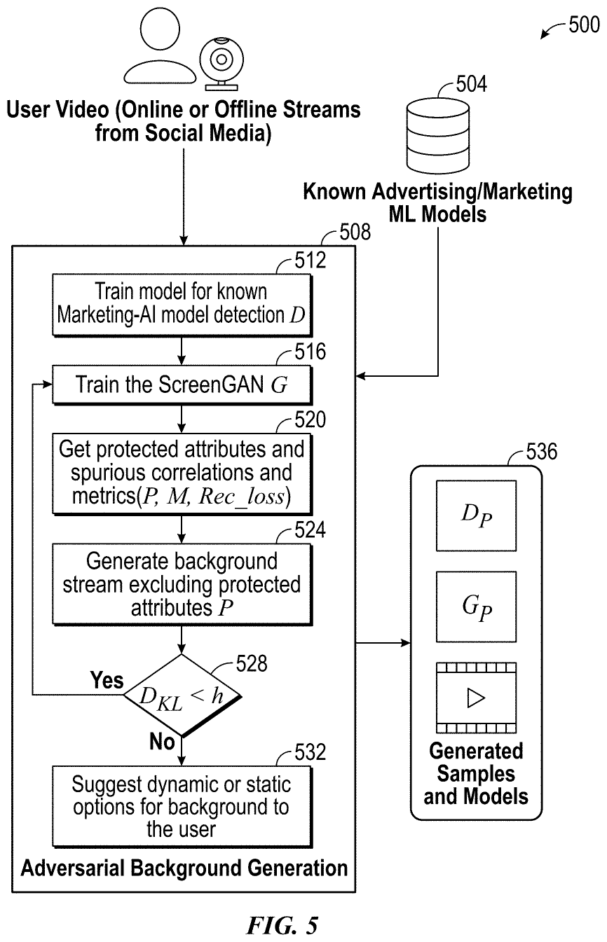

FIG. 5 is a system overview of an example adversarial data generation system 500, in accordance with an example embodiment. A database 504 of known marketing machine learning models are utilized by an advertisement device 508 to perform marketing tasks, such as identifying target groups. A model for a known AI model detection D is trained for performing the marketing task (operation 512). A generative adversarial network (GAN) g, referred to as ScreenGAN herein, is trained to generate adversarial data (operation 516). In one example embodiment, the GAN utilizes semi-supervised learning, thereby requiring, at most, a limited number of labelled samples. The GAN is trained to add noise to the media under consideration (such as video, audio, speech, text, graphics, and the like) until the GAN can no longer detect the protected attributes. Protected attributes, spurious correlations and metrics (P, M, Rec_loss) are obtained (operation 520). For example, the protected attribute, protected cues, and spurious correlations are obtained by performing the method 300 of FIG. 3. The media being utilized (such as the video, audio, speech, text, graphics, and the like) is generated by generating and incorporating the adversarial data into the original media to eliminate the protected attribute and spurious correlations from the media (operation 524). For example, a background stream of a video may be generated that incorporates the adversarial data and thereby excludes the protected attributes P from the generated background stream. A check is performed to determine if the GAN is still able to detect each protected attribute, protected cue, and spurious correlation in the video, that is, to determine if D_{KL}<h (decision block 528). If the GAN is still able to detect each protected attribute, protected cue, and spurious correlation in the video (YES branch of decision block 528), the method 500 proceeds with operation 516 and the GAN is further trained; otherwise (NO branch of decision block 528), dynamic or static options for the adversarial data are suggested (operation 532). The static option utilizes the same noise (adversarial data) for, for example, all frames of a video. The dynamic option utilizes different noise (adversarial data) for, for example, at least some frames of the video. In one example embodiment, the use of adaptive noise may be automatically triggered if the GAN detects, once again, one or more of the protected attributes, protected cues, and spurious correlations after previously eliminating all of the protected attributes, protected cues, and spurious correlations under consideration. Based on the selected option (static option or dynamic option), the media is modified to incorporate the adversarial data and is stored with the AI models in a database 536.

In one example embodiment, different types of adversarial data are generated based on the type of media. For example, known natural language processing techniques can be utilized to incorporate adversarial data into textual media and known speech processing techniques can be utilized to incorporate adversarial data into audio media.

Generate Adversarial Artifacts

Given a dataset (X, Y, Proc), in one or more embodiments, ScreenGAN aims to generate a protected dataset (\hat{X}, \hat{V}) which achieves an obfuscation of a set of protected attributes Proc while ensuring that the generated sample is substantially the same for, for example, the human eye. In one example embodiment, the generator (G_{screen}) and two discriminant networks (Dₚ and Dᵣ) are employed. Dₚ is in charge of classifying the protected attribute and constraining the media, such as a video, to only show frames that are able to confuse the type of protected attribute and Dᵣ is in charge of discriminating if the sample is real or generated. Z is a noise variable given a set of protected attributes p∈Proc:

\hat{x}, ŷ=G_{screen}(z, p), z˜P_{z}(z)

The generated sample comes from a joint distribution: P_{G}_{_{screen}}(x,y|s)P_{data}(p)

$${min max V}_{{G}_{Screen} {D}_{r} , {D}_{p}} ( {G}_{Screen} , {D}_{r} , {D}_{p} ) = {V}_{r} ( {G}_{Screen} , {D}_{r} ) + β {V}_{p} ( {G}_{Screen} , {D}_{p} )$$

where β is a parameter to determine how important it is to obfuscate that particular attribute p. The first term of the minmax is in charge of optimizing for the frames to look real (a small perturbation that will not change the structure of the frame) and the second term is in charge of generating a representation in which the attribute cannot be correctly inferred.

Use Cases

The disclosed systems, methods, and techniques can be used in a variety of environments. In one example embodiment, a company may audit an AI system for advertisement management to be used for a marketing pipeline. If a company uses third party software, a determination can be made of whether the AI system is biased for subgroups of potential users. In this scenario, if the company has access to all the models that are used by the advertisement software (in a white-box example), the protected attributes do not need to be inferred.

In a second use case, a company provides the potential AI marketing model, knowledge graph, and a set of example candidate data that contains video, audio, graphics, text, or any combination thereof. The system takes as inputs: the AI marketing model to audit the system, a knowledge graph, and a set of example candidate data. The system detects protected attributes and features that adversely impact the decision making of the given AI marketing model and generates adversarial artifacts to control the information used by the model by masking the protected attributes and features.

Given the discussion thus far, it will be appreciated that, in general terms, an exemplary method, according to an aspect of the invention, includes the operations of identifying protected features from media 404, 408, 412 that enable bias in a decision-making process of an artificial intelligence (AI) system 500 (operation 336); ranking the identified protected features (operation 344); generating, using a generative adversarial network 420, adversarial artifacts to obfuscate at least a portion of the ranked protected features (operation 524) (e.g., the highest ranked protected features); and integrating the adversarial artifacts into the media 404, 408, 412 (operation 524).

In one example embodiment, the protected features comprise one or more of protected attributes, protected cues, and spurious correlations. In one example embodiment, knowledge information on the artificial intelligence system 500 and a plurality of features from the candidate media 404, 408, 412 are obtained (operation 304) and a type characteristic of a model 420 of the artificial intelligence system 500 is determined, wherein the identification step is based on the type characteristic of the model 420 (operation 308).

In one example embodiment, prospecting for candidate features of a model 420 of the artificial intelligence system 500 is performed using modification-triggered prediction drift evaluation (operation 328), where the identification operation comprises selecting one or more of the candidate features as the protected features 428-432. In one example embodiment, the generation of the adversarial artifacts further comprises adaptively modifying the generation operation in response to detecting one or more of the protected features in a modified portion of the candidate media 404, 408, 412 (decision block 528 and operation 516). In one example embodiment, the adversarial artifacts are used to alter a background of an image of the candidate media 404, 408, 412 (operation 524).

In one example embodiment, the generative adversarial network 420 comprises a generator G_{screen}, a first discriminant network Dₚ 536 that serves to classify the protected features and constrain the media 404, 408, 412 to confuse a corresponding type of protected feature, and a second discriminant network Dᵣ 536 that serves to discriminate whether a given sample is real or generated, wherein Z is a noise variable given a set of protected attributes p∈Proc, wherein:

\hat{x}, ŷ=G_{screen}(z, p), z˜P_{z}(z)

wherein the generating and integrating operations are based on a joint distribution:

$$\begin{matrix}{P}_{{G}_{Screen}} ( x , y \vert s ) {P}_{data} ( p ) \\ {min max V}_{{G}_{Screen} {D}_{r} , {D}_{p}} ( {G}_{Screen} , {D}_{r} , {D}_{p} ) = {V}_{r} ( {G}_{Screen} , {D}_{r} ) + β {V}_{p} ( {G}_{Screen} , {D}_{p} )\end{matrix}$$

wherein β is a parameter to determine an importance level of obfuscating a specified attribute p. In one example embodiment, the generative adversarial network 420 comprises a generator, a first discriminant network 536 that serves to classify the protected features and constrain the media 404, 408, 412 to confuse a corresponding type of protected feature, and a second discriminant network 536 that serves to discriminate whether a given sample is real or generated, wherein a first term of a minmax function of the generative adversarial network optimizes for the integrated media to match the unintegrated media and a second term of the minmax function causes a generation of a representation of the integrated media in which the at least a portion of the protected features are obfuscated. In one example embodiment, inferencing is performed by the artificial intelligence (AI) system 500 using the media 404, 408, 412.

In one aspect, an apparatus comprises a memory and at least one processor, coupled to the memory, and operative to perform operations comprising identifying protected features from media 404, 408, 412 that enable bias in a decision-making process of an artificial intelligence (AI) system 500 (operation 336); ranking the identified protected features (operation 344); generating, using a generative adversarial network 420, adversarial artifacts to obfuscate at least a portion of the ranked protected features (operation 524); and integrating the adversarial artifacts into the media 404, 408, 412 (operation 524).

In one aspect, a computer program product comprises a computer readable storage medium having program instructions embodied therewith, the program instructions executable by a computer to cause the computer to perform operations comprising identifying protected features from media 404, 408, 412 that enable bias in a decision-making process of an artificial intelligence (AI) system 500 (operation 336); ranking the identified protected features (operation 344); generating, using a generative adversarial network 420, adversarial artifacts to obfuscate at least a portion of the ranked protected features (operation 524); and integrating the adversarial artifacts into the media 404, 408, 412 (operation 524).

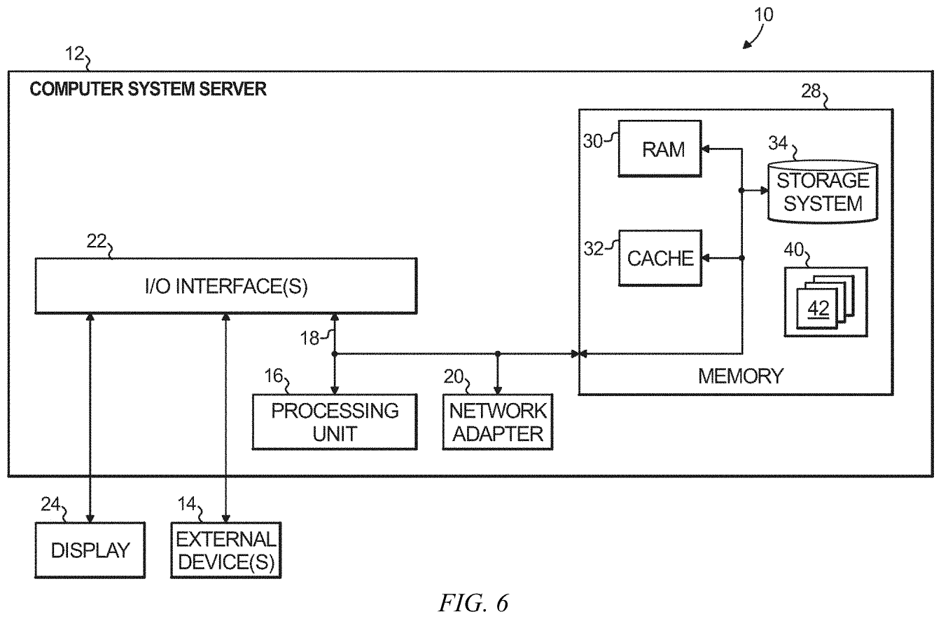

One or more embodiments of the invention, or elements thereof, can be implemented in the form of an apparatus including a memory and at least one processor that is coupled to the memory and operative to perform exemplary method steps. FIG. 6 depicts a computer system that may be useful in implementing one or more aspects and/or elements of the invention, also representative of a cloud computing node according to an embodiment of the present invention. Referring now to FIG. 6, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 6, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 6) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying protected features from media that enable bias in a decision-making process of an artificial intelligence (AI) system;
ranking the identified protected features;
generating, using a generative adversarial network, adversarial artifacts to obfuscate at least a portion of the ranked protected features; and
integrating the adversarial artifacts into the media.

2. The method of claim 1, wherein the protected features comprise one or more of protected attributes, protected cues, and spurious correlations.

3. The method of claim 1, further comprising:
obtaining knowledge information on the artificial intelligence system and a plurality of features from the media; and
determining a type characteristic of a model of the artificial intelligence system, wherein the identification step is based on the type characteristic of the model.

4. The method of claim 1, further comprising prospecting for candidate features of a model of the artificial intelligence system using modification-triggered prediction drift evaluation, where the identification operation comprises selecting one or more of the candidate features as the protected features.

5. The method of claim 1, wherein the generation of the adversarial artifacts further comprises adaptively modifying the generation operation in response to detecting one or more of the protected features in a modified portion of the media.

6. The method of claim 1, further comprising using the adversarial artifacts to alter a background of an image of the media.

7. The method of claim 1, wherein the generative adversarial network comprises a generator, a first discriminant network that serves to classify the protected features and constrain the media to confuse a corresponding type of protected feature, and a second discriminant network that serves to discriminate whether a given sample is real or generated, wherein a first term of a minmax function of the generative adversarial network optimizes for the integrated media to match the unintegrated media and a second term of the minmax function causes a generation of a representation of the integrated media in which the at least a portion of the protected features are obfuscated.

8. The method of claim 1, further comprising performing, by the artificial intelligence (AI) system, inferencing using the media.

9. An apparatus comprising:
a memory; and
at least one processor, coupled to said memory, and operative to perform operations comprising:
identifying protected features from media that enable bias in a decision-making process of an artificial intelligence (AI) system;
ranking the identified protected features;
generating, using a generative adversarial network, adversarial artifacts to obfuscate at least a portion of the ranked protected features; and
integrating the adversarial artifacts into the media.

10. The apparatus of claim 9, wherein the protected features comprise one or more of protected attributes, protected cues, and spurious correlations.

11. The apparatus of claim 9, the operations further comprising:
obtaining knowledge information on the artificial intelligence system and a plurality of features from the media; and
determining a type characteristic of a model of the artificial intelligence system, wherein the identification step is based on the type characteristic of the model.

12. The apparatus of claim 9, the operations further comprising prospecting for candidate features of a model of the artificial intelligence system using modification-triggered prediction drift evaluation, where the identification operation comprises selecting one or more of the candidate features as the protected features.

13. The apparatus of claim 9, wherein the generation of the adversarial artifacts further comprises adaptively modifying the generation operation in response to detecting one or more of the protected features in a modified portion of the media.

14. The apparatus of claim 9, the operations further comprising using the adversarial artifacts to alter a background of an image of the media.

15. The apparatus of claim 9, wherein the generative adversarial network comprises a generator, a first discriminant network that serves to classify the protected features and constrain the media to confuse a corresponding type of protected feature, and a second discriminant network that serves to discriminate whether a given sample is real or generated, wherein a first term of a minmax function of the generative adversarial network optimizes for the integrated media to match the unintegrated media and a second term of the minmax function causes a generation of a representation of the integrated media in which the at least a portion of the protected features are obfuscated.

16. The apparatus of claim 9, the operations further comprising performing, by the artificial intelligence (AI) system, inferencing using the media.

17. A computer program product, the computer program product comprising a computer readable storage medium having program instructions embodied therewith, the program instructions executable by a computer to cause the computer to perform operations comprising:
identifying protected features from media that enable bias in a decision-making process of an artificial intelligence (AI) system;
ranking the identified protected features;
generating, using a generative adversarial network, adversarial artifacts to obfuscate at least a portion of the ranked protected features; and
integrating the adversarial artifacts into the media.

18. The computer program product of claim 17, the operations further comprising:
obtaining knowledge information on the artificial intelligence system and a plurality of features from the media; and
determining a type characteristic of a model of the artificial intelligence system, wherein the identification step is based on the type characteristic of the model.

19. The computer program product of claim 17, the operations further comprising prospecting for candidate features of a model of the artificial intelligence system using modification-triggered prediction drift evaluation, where the identification operation comprises selecting one or more of the candidate features as the protected features.

20. The computer program product of claim 17, wherein the generation of the adversarial artifacts further comprises adaptively modifying the generation operation in response to detecting one or more of the protected features in a modified portion of the media, the operations further comprising using the adversarial artifacts to alter a background of an image of the media.
